(19) United States
(12) Patent Application Publication
(10) Pub. No.: US 2008/0255870 A1
(43) Pub. Date: Oct. 16, 2008

(54) Systems and Methods for Grouping Kiosk Users and Non-Users into a Community

(76) Inventor: Jon Butler, Salt Lake City, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 12/101,742

(22) Filed: Apr. 11, 2008

Related U.S. Application Data
(60) Provisional application No. 60/911,769, filed on Apr. 13, 2007.

(51) Int. Cl. G06Q 99/00; G06F 15/16

(52) U.S. Cl. 705/1; 709/204

(57) ABSTRACT

Systems and methods for grouping individual kiosk users into one or more communities are described. The described systems and methods may further group people who have not used a kiosk into one or more communities. Additionally, the systems and methods may make information or data about a particular user and/or the user's activities at a kiosk available to members of a community, which may include users and/or non-users. The systems and methods also make the information about one or more communities available to a single user or non-user. The information may include user data, kiosk data, community data, location data, and the like. The data can be collected and reported to the individual and/or the community on a real-time or substantially real-time basis. The data reported can be then used for various purposes, including customizing the advertising for an individual user or community, statistical marketing analyses, viral marketing, or any other purpose. The information can result in increased consumer communication and awareness as well as savings for an individual user or non-user. Other embodiments are described.

### CROSS-REFERENCE TO RELATED APPLICATION

This application claims priority to U.S. Provisional Patent Application No. 60/911,769, filed Apr. 13, 2007, the entire disclosure of which is hereby incorporated by reference.

### FIELD

This application relates generally to systems and methods for grouping individual kiosk users and non-users into a community. In particular, this application relates to systems and methods for making information about a particular user and/or the user's activities at a kiosk available to other users as well as to non-users.

### BACKGROUND

Many types of information and content are now stored digitally, including books, music, movies, software programs, video games, databases, advertisements, as well as other content. Because such content is stored digitally, it can be transferred easily using many types of electronic networks. See, for example, U.S. Pat. Nos. 5,875,110, 4,412,292, 5,848,398, 6,397,189, 6,381,575, 4,674,055, 5,445,295, 5,734,719, 6,286,029, 6,799,165, 6,655,580, 6,330,490, 6,662,080, 6,535,791, 6,711,464, 5,237,157, 6,654,757, 5,794,217, and 6,748,539. Both private and public electronic networks, including the Internet, are frequently used to transfer the digital content.

Often the digital content is transferred electronically so that it can be sold to an end-user who is not located where the digital content is originally stored. The digital content can be sold for a variety of purposes, including education, entertainment, research, or other purposes. The digital content may be sold in any number of technological formats known in the art that permit storage and retrieval of the digital data, including floppy discs, compact discs of several varieties; video discs of several varieties, including digital video discs; magnetic storage devices using a variety of forms and technologies; and solid state devices of several varieties.

Most digital content sales have been to users of computers that are connected to each other via networks of various types, e.g., the Internet. But users are not always located at such a computer when they desire to purchase the digital content, or they have a computer but it is not connected to a network. Consequently, sales of digital content have begun using devices in remote locations, including stand-alone devices (such as kiosks) in retail or other high-traffic areas. The stand-alone devices may be attended or unattended.

In such instances, it has become common to gather data about the user and/or the user's activities. Such data can be used for numerous purposes, including being reported to third parties to be used for various purposes, including advertising or sales. But the data being collected about an individual user's activities is not usually made available to other users of the kiosks or to other people of the user's choice.

### SUMMARY

Systems and methods for grouping individual kiosk users into one or more communities are described in this application. The described systems and methods may further group people who have not used a kiosk into one or more communities. Additionally, the systems and methods may make information or data about a particular user and/or the user's activities at a kiosk available to members of a community, which may include users and/or non-users. The systems and methods also make the information about one or more communities available to a single user or non-user. The information may include user data, kiosk data, community data, location data, and the like. The data can be collected and reported to the individual and/or the community on a real-time or substantially real-time basis. The data reported can be then used for various purposes, including customizing the advertising for an individual user or community, statistical marketing analyses, viral marketing, or any other purpose. The information can result in increased consumer communication and awareness as well as savings for an individual user or non-user.

### BRIEF DESCRIPTION OF THE DRAWINGS

The following description can be better understood in light of the Figures, in which:

FIG. 1 depicts a block diagram representing an exemplary distributed networking system for delivering digital content;

FIG. 2 illustrates a block diagram representing some of the components in an exemplary kiosk;

FIG. 3 illustrates some methods for a collecting and sharing information from a user's interaction with a kiosk with a community, including internet and distribution channels; and

FIG. 4 illustrates methods for collecting and sharing information from a user and/or the user's activities at a kiosk.

Together with the following description, the Figures may demonstrate and explain the principles of the systems and methods for making information about a particular user and/or her activities at a kiosk available to other users and/or non-users, including groups or communities of users or non-users, and vice versa. In the Figures, the thickness and configuration of components may be exaggerated for clarity. The same reference numerals in different Figures represent the same component.

### DETAILED DESCRIPTION

The following description provides specific details in order to provide a thorough understanding. The skilled artisan, however, would understand that the systems and methods can be practiced without employing these specific details. Indeed, the systems and methods can be practiced by modifying the illustrated system and method and can be used in conjunction with apparatus and techniques conventionally used in the industry. While the systems and methods are described for use with a kiosk as a remote device, the remote device could include other types of devices, such as many types of wireless computing devices, consumer electronic devices, military devices, or others.

The systems described herein can deliver digital content (or content) from a first location to one or more second locations that are optionally remote from the first location. Accordingly, the systems contain a first device in a first location where the digital content can be stored, a second device in a second location for delivering the digital content to an end-user, and means for transferring the digital content from the first location to the second location. The systems can also collect data from the device(s) in the second location(s) and report that data to the device in the first location, to device(s) in another second location, or even to device(s) or locations outside the system.

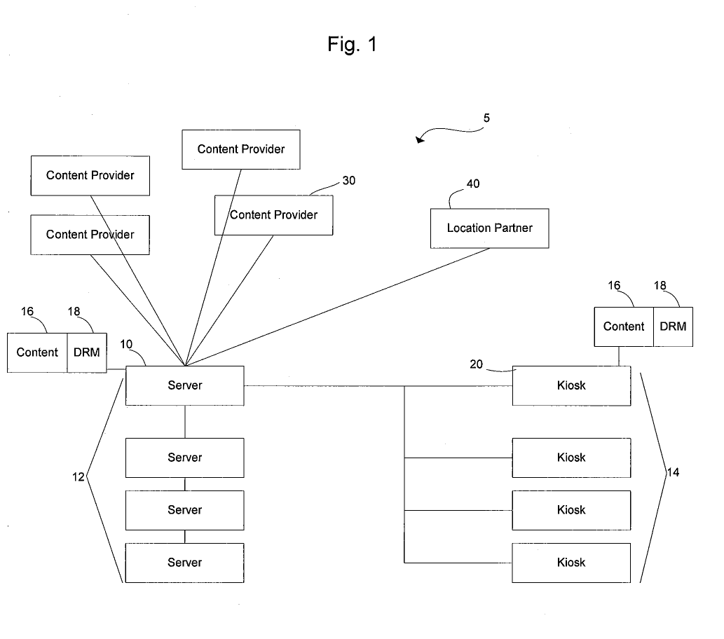

In some aspects, the systems for delivering content are illustrated in FIG. 1. As depicted in that Figure, the system 5 contains a first device (i.e., server 10) located in a first location. The first location can be located anywhere desired by the operator, i.e., in a central location (with central not referring to the geographic location). The first device acts as a repository for the digital content. Any device that can operate as a repository can be used as the first device.

One example of the first device comprises a server 10. Any type of server known in the art can be used as server 10. Examples of servers that can be used include a computer running a UNIX-style operating system, a computer running a Microsoft Windows operating system, or a personal computer workstation. The server 10 comprises any storage component on which the digital content can be stored. Examples of storage components include optical storage discs, DVD-RAM discs, and traditional magnetic hard disc drives. Another example includes remote databases.

In some aspects, multiple servers 12 may be connected together to make a server cluster. Using a server cluster permits sharing information regarding the content stored on each server 10 and each transaction the server 10 has recorded. By using a server cluster, the system 5 is always operational, regardless of the location of a particular component on the network that connects the components (such as the Internet). The server cluster can contain a primary cluster, which handles all critical tasks, with minor functions being routed to a secondary cluster. With this configuration, if the primary cluster is not operational, most functions can be handled by the secondary cluster. A server cluster also allows a large-scale deployment and interoperability, as well as data that can be stored on the network in multiple points of co-location.

The software components required for operating the server 10 may be included on a single server or on multiple servers, with each server implementing one or more tasks and communicating among themselves using standard networking protocols. Non-limiting examples of the server-focused tasks using the software components that may be implemented on one or more servers 10 include those of e-mail server; Web server; file server; purchase transaction authentication server; content security server; and advertising message server.

As depicted in FIG. 1, the server 10 contains digital content 16. The types of digital content 16 that can be delivered are virtually unlimited. Examples of the digital content include music, movies, video games, software, mobile phone ring tones, electronic books, advertising, and other types of content. The format in which the digital content is stored is also virtually unlimited. Examples of the types of digital formats include pdf, doc, xls, jpeg, tiff, gif xbm, pnm, mpeg2, mpeg4, mp3, wma, wmv, mov, wav, and avi, as well as combinations thereof. The digital content can also be provided in any known language.

The digital content 16 may be provided internally (by the entity that controls or operates the server 10), or externally by one or more third parties that are the copyright owners of the content or that act on behalf of the owners of the content (collectively, content providers 30). Non-limiting examples of content providers 30 include music publishers, recording companies, book publishers, artists, performers, end-users, mobile telephone companies, video game manufacturers, and advertisers. Content providers 30 may provide the content 16 to the server using any known mechanism, including via network connections known in the art or via other methods, such as providing a CD or DVD to the operator of a server 10.

The digital content 16 can include instructions indicating how the content may be used, distributed, sold, transmitted, or otherwise processed (use instructions). The server 10 can convert such use instructions into digital rights management (DRM) information 18 that can be associated with any desired content. The DRM information may include any number or combination of restrictions, including those that are enabled by a DRM technology and that are selected by a content provider 30. Non-limiting examples of DRM restrictions include a restriction that visual or textual content not be printed in hardcopy; a restriction that copy-and-paste functions are disabled for textual content; a restriction that a music file may not be played after a certain date; a restriction that a music file or video file may only be played a fixed number of times; and a restriction that a file may only be copied to another device a fixed number of times. Other examples include variable pricing, variable billing, and variable payment methods.

The DRM information may be provided by a third party (such as content provider 30 or location partner 40) or by the operator of a server 10. Either may assign a unique transactional ID to each piece of content 16. This unique transactional ID correlates to a set of use instructions and DRM specifications to control how the associated content is managed on devices, such as on the server 10, as further described hereinafter. The content 16 may therefore contain metatags, use instructions, and a transactional ID.

The content 16 may also contain metatags that correspond to information about any desired content, such as a genre of music or movie, an artist, a content provider, or otherwise. Metatags may be provided by a content provider 30 or created by the operator of a server 10. The metatags may indicate the use instructions for all content that is provided, with distinct use instructions for each piece of content, or with use instructions based on parameters that can be used to classify content. In one example of use instructions, a content provider 30 may indicate that music performed by musical artist A may be redistributed freely, without restriction, music performed by musical artist B may be redistributed freely when purchased at a set price, and music performed by musical artist C may be redistributed in a manner that permits the music to be copied to another computer three times, after which the music may not be copied to another computer, but only played (performed) on a computer where it is stored.

The content 16 may optionally be encrypted in a manner to increase security of the content during storage on a server 10 or on a kiosk 20, or during transfer between a content provider 30 and a server 10, or between a server 10 and a kiosk 20. Any number of encryption methods known to those in the art may be used to implement this feature. Examples of such encryptions include both symmetrical and asymmetrical encryption using a variety of methods, including RSA, DES, Triple DES, Blowfish, ElGamal, RC4, and others.

When the second device is placed in a location that is remote from the first device, a location partner 40 can optionally be used in the system 5 as depicted in FIG. 1. The location partner 40 comprises an individual or entity that provides a space where the second device may be physically located. Non-limiting examples of such location partners include owners or managers of airports, bars, clubs, schools, gyms, stadiums, arenas, amusement parks, military bases, retail centers or shops, and eating establishments.

A location partner 40 may provide this space without charge, as a service to individuals that visit the space where the second device is placed. Or the location partner 40 may provide this space in exchange for a fee of some type, or in exchange for advertising time on the second device, or for other benefits. In some aspects, the location partner 40 may control or limit the content that is available via the second device. In other embodiments, the location partner can also control the advertising.

As described above, the system also contains a second device that can be located in a second location that is optionally remote from the first location. The second device receives the content from the first device and then distributes that content to an end-user. Any device operating in this manner can be used as the second device. In some aspects, the second device comprises a kiosk 20 as depicted in FIG. 1.

Kiosk 20 provides a point-of-sale experience for any user, including both actual and merely potential purchasers of the content. Any person can be a user by interacting with the kiosk 20, whether by purchasing content or merely viewing the kiosk 20 and/or the content on the kiosk, such as by sampling music contained in the kiosk. The kiosk 20 used in the system can be any kiosk known in the art or the kiosk described below. In some embodiments, the kiosk may physically display any known advertising, such as posters, banners, or adhesive advertisements. The kiosk 20 may be used in conjunction with products as a point-of-purchase display.

The kiosk 20 can contain any combination of number of video displays. In some aspects, the kiosk 20 contains two video displays, a first video display that displays advertising messages and a second video display that displays menus, samples of content and related information appropriate to affect a purchase by an end-user of the content made available through the kiosk 20.

The kiosk 20 can also contain multiple input and output devices appropriate to interact with an end-user, display or perform the content stored on the kiosk 20, and complete a sales transaction related to the content. These input and output devices may include, for example, one or more of any of the following: a keyboard; a mouse; a trackball; a joystick; a touchscreen; a LED display; a LCD display; a label maker; an automatic coupon feeder; a barcode scanner; an image scanner; biometric scanning devices such as a fingerprint, voiceprint, hand geometry, or retinal/iris scanner; a Compact Disc reader; a Compact Disc writer; a video disk reader; a video disk writer; and media device connectivity, including a USB port, an IEEE-1394 FireWire port, a SecureDigital (SD) port, a CompactFlash port, a PCMCIA port, a MemoryStick port, a laser printer, a receipt printer, a video camera, a camera, an audio recorder, a credit/debit/gift card reader, a cash acceptor, a coin acceptor, a check acceptor, a jewel case ejector, a phone docking station, speakers, voice recognition device, signature verifier, facial recognition device, Braille input device, bubble sheet/multiple choice form scanner (such as a Scantron machine), Bluetooth communications, Wi-Fi communications, and others known in the art. Furthermore, additional input, output, and storage technologies known in the art may be integrated with the kiosk 20 and the system 5, including any and all mobile or portable devices or credit cards.

The kiosk 20 can also include a controlling device that operates the video displays, interacts with input and output devices, and communicates with other kiosks 20 or servers 10, in real-time or as needed. In some aspects, the controlling device includes two or more computers, either sharing or dedicated to the needed tasks requisite to controlling operation. In some aspects, one computer handles the display, selection, and processing of content purchase transactions and a second computer handles the display of advertising messages.

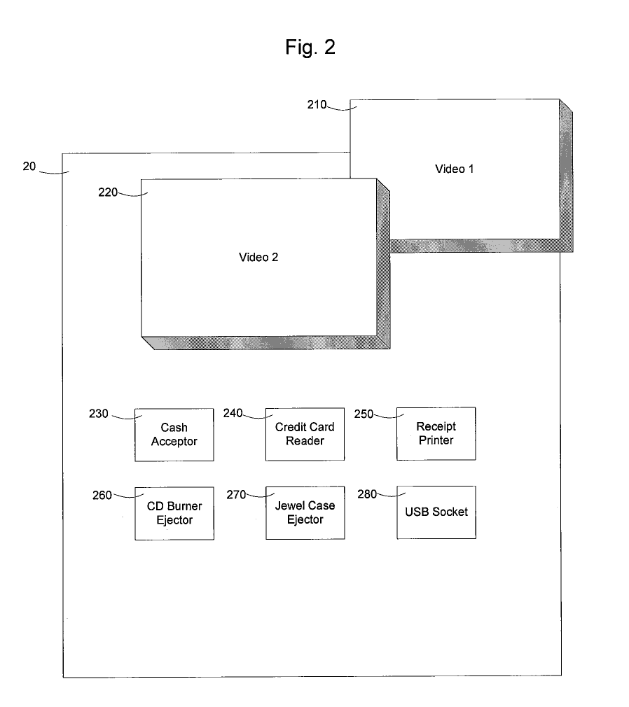

FIG. 2 illustrates one example of kiosk 20. In FIG. 2, kiosk 20 contains a video display 210 on which advertising messages are displayed; a video display 220 comprising a touch screen device through which an end-user may view and select content; a cash acceptor 230 through which an end-user may make payment for content; a credit card reader 240 through which an end-user may make payment for content; a receipt printer 250 that dispenses a paper receipt of a transaction when content is purchased; a CD burner ejector 260 that dispenses an audio CD containing content selected by an end-user during a purchase transaction; a jewel case ejector 270 that dispenses an empty jewel case for holding an audio CD; and a USB socket 280 to which an end-user may connect a device for delivery of content, as described in this specification. As noted previously, a kiosk 20 may contain different-or additional-components than those shown in FIG. 2, including an end unit that is a mobile or portable device.

When a user purchases content 16 through a kiosk 20, that content is made available using any delivery device known in the art. Non-limiting examples of delivery devices can include: audio CD, DVD or similar video or data disc, writeable data CD such as WORM or CD-RAM, magnetic and solid state storage devices that communicate with a kiosk 20 via any means known in the art, and hard-copy paper. In some aspects, the content can be placed on a delivery device that can include plug-ins or software that has advertising integrated and can be used to play the content received.

The various components of the system can be electronically connected to each other using any means known in the art. Examples of these connections include Ethernet, frame relay, DSL, satellite uplink, cable modem, analog modem, fibre channel, infrared and microwave transmissions, wireless communications of various types, and other networking technologies known in the art. Such connections may also be constructed through a publicly accessible network, such as the Internet, so long as appropriate security measures, as are known in the art, are used to prevent unauthorized access to the content that passes across the connection. A private network connection may also be used in order to reduce the reliance on such security measures and to further ensure the integrity of content that is transferred via this connection.

The various components of the system are able to communicate with each other whenever needed. In some aspects, server 10 and a kiosk 20 may communicate at regular or scheduled intervals, in real-time, or in an ad hoc manner according to needs that arise as determined by the server 10 or the kiosk 20. Since actual real-time communication may be limited by the transmission speeds available, the communication may be on a substantial or near real-time basis.

In some aspects, the various components of the system need not be electronically connected. For example, the kiosk 20 need not be connected to the server 10 on a continuous basis. Rather, the kiosk operates in a stand-alone mode, with content being transferred to the kiosk 20 via non-networked means, and purchase transactions and demographic data being collected via non-networked, intermittent means. A stand-alone kiosk 20 can be used, for example, when security procedures or network connectivity are not available, such as a kiosk 20 located on a military base in a different country than the server 10 from which it would otherwise receive content. The kiosk can also be integrated with other carriers and delivery systems.

The systems described above can be used to transfer the digital content from the first device to the second device, where it then can be optionally distributed to an individual user. While the digital content 16 can be transferred by the system in any manner, in some aspects, it can be transferred in a semi-dynamic manner, dynamic, or even static manner. The digital content can also be transferred to a third device or a group of devices at once.

When the content is transferred from the server to the kiosk, the operator of a server 10 may customize which content (or category, group of content, or advertising) is transferred semi-dynamically, customize which content is transferred from a server 10 to a particular kiosk 20 (or to a collection of multiple kiosks 14), as well as customize the billing.

When a user views the kiosk, purchases content, or otherwise interacts with the kiosk, the kiosk may collect any desired type of data (collected data). Some examples of collected data may include data about the individual user (user data), data about the user's interaction with the kiosk (kiosk data), data relating to kiosk communities (community data), data concerning the demographics of the kiosk location (location data), and so forth.

For example, during the user's interaction with the kiosk, the kiosk may gather user data. User data may include any information that relates to the user and/or the user's activities. One example of user data may include conversion data, such as pages viewed, images viewed, color schemes viewed, time of viewing, time of viewing in relation to purchase, content 16 or item(s) purchased/downloaded, requests made, demos/games played, registrations, signups, advertisements viewed, and so forth. Another example of user data may include user browsing activities, such as content viewed, content selected, time spent viewing different content, and total interaction time. Yet another example of user data may be demographic information, such as the user's age, sex, ethnicity, race, marital status, household size, schooling/education, income, profession, languages spoken, citizenship, and the like. Still another example of user information may include survey data, such as consumer satisfaction surveys, event expectation surveys, post-event evaluation surveys, polling/voting data, and so forth. Another example user data may include user preference data, such as user selected color schemes, content preferences, advertisement preferences, e-mail preferences, and the like. Another example of user data includes user-indicated items of interest, such as forms and genres of entertainment and hobbies. In yet another example, user data may include user account information, such as username, password, address, phone number, e-mail address, unique login identifiers, cookies, user specific survey/conversion data, etc. In still another example, user data may include biometric data, such as fingerprints, voiceprints, hand geometries, retinal/iris scans, signature verifications, facial recognitions, video feed of end-user, pictures taken of end-user, audio recordings, and the like. Moreover, additional information may be collected and/or extrapolated from the any information/data that has been input by the user.

The collected data also includes kiosk data. The kiosk data can include and of the user's interaction with the kiosk including, as non-limiting examples, the following: the areas of the content navigation system visited by the end-user; the advertising content displayed immediately prior to and during the end-user's interaction with the kiosk; the advertising content displayed immediately prior to and during the end-user's purchase from the kiosk; the nature of the delivery device selected by the end-user; method of payment, and others. For instance, the kiosk data may also include sales transaction data, which may indicate purchases contemplated or completed by the end-user, content sold, content price, royalty information, license numbers, inventory ID numbers, transactional IDs, etc.

The collected data may also include community data. Community data may include any data relating to a group or groups of kiosk users and non-users (people who have never interacted with the kiosk) as well as communications among the group(s). It should be noted that there can be multiple communities of users and/or non-users, and even communities within a given community. Thus, communities can be overlapping, so that an individual member or members of a community can be a part of many communities at once. Similarly, communities may be encompassing, so that one community can completely include another. Thus, community data may relate to one or more communities with various relationships to each other.

In some embodiments, community data may include information regarding different communities that an individual user may want to join. For example, a user may directly or indirectly (e.g., according to type of content viewed, preferences selected, etc.) indicate a desire to join a community centered on a particular theme (contemporary music), genre (e.g., country music), characteristic (friends, family, age, ethnicity, etc,), or the like. In another example, a user may indicate a desire to join a group centered on a particular artist (e.g., Garth Brookes), a particular artist in a particular locality (e.g., Garth Brookes fans in Peoria), etc. Yet another example of community data may include information about different groups or communities the user would like to form. For instance, the user may input community data that includes a central theme for a new community (e.g., a specific genre of media, the user's friends, the user's family, etc.) as well as information about people the user would like to add to the community (e.g., names, e-mail addresses, demographic data, etc.). The individual user may input information regarding other users or non-users that may be added to an existing community. Accordingly, the user could choose to add more people to a community comprising friends and family. Yet another example of community data may include selections of content samples, messages, comments, or other information (e.g., comments or messages) a user would like to send to a particular community or to one or more individual non-users.

The collected data may also include location data. The location data may relate to the demographic environment at the location of the remote device, i.e., print/design advertising or products associated with remote device, kiosk location, seismic/meteorological activity, local advertisements, local artists, local event calendaring, and so forth.

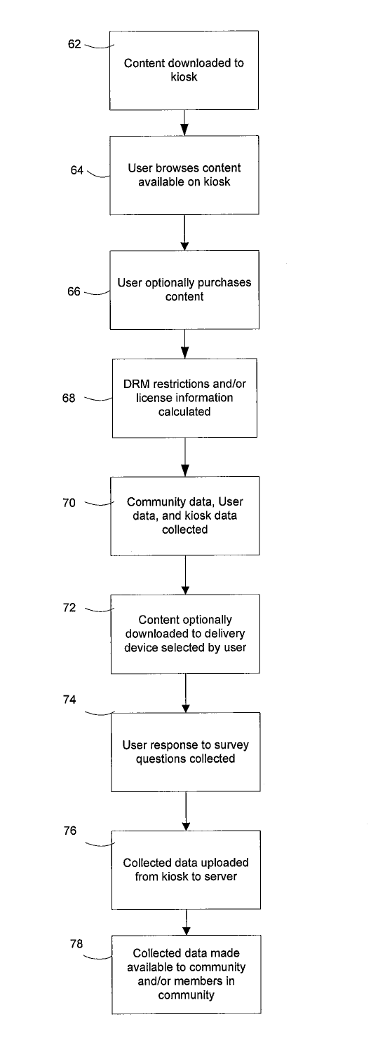

The collected data may also include other types of data than these categories. Examples of other types of data include payment information, sales information, credit/debit/gift card information, promotional/discount codes, accounting information, and so forth. The kiosk (or other remote device) may collect the data in any manner. In some embodiments, the data is collected during a user's interaction with a kiosk. One example of a typical user interaction with the kiosk is illustrated in FIG. 3. Nevertheless, one skilled in the art will appreciated that many variations are possible as to the steps followed by a particular user and that the following steps need not be followed sequentially. Block 62 of FIG. 3 shows that if the content is not already present at the kiosk, it may be transferred to the kiosk. At block 64 in FIG. 3, the end-user can optionally view advertising on the first video screen and may optionally begin to use an input device located on or adjacent to the kiosk to navigate among a collection of content that is available for review or sale via the kiosk. At that point, the user may optionally experience samples of content via the first or second video screen or another output device located on or adjacent to the kiosk. For example, the user can listen to the first 30 seconds of a music file that is available for purchase via the kiosk.

Next at block 66, the user can then optionally select content to be acquired, typically by paying a purchase price, and entering payment information as appropriate to the transaction. This payment information can then be verified in real-time. Additionally, the user can take advantage of multiple payment methods, i.e., cash, credit, debit, promotions, loyalty programs, reward programs, etc.

At any time during the interaction, the kiosk may gather collected data from the user. For example, as illustrated at 68, the user may choose to enter community data into the kiosk after purchasing content. In this example, the user may select one or more communities the user would like to join. Additionally, the user may choose to enter information relating to other users or non-users and thereby create a user defined community. In another example, the kiosk may gather user data, kiosk data, or any other desired information from the user during the transaction.

At block 70 in FIG. 3, the method may continue when DRM restrictions and/or license information are calculated as needed and associated with the content that was selected for purchase. As shown at block 72, the user can select a delivery device onto which the content 16 will be placed for use by the end-user and the content 16 may be delivered to the selected delivery device. Then the user may continue to input information during the remainder of the transaction. For instance, block 74 shows that after the user has selected a delivery device for purchased content, the user may answer a survey or in other way reveal user data, kiosk data, community data, or any other information. This process may optionally be completed while payment information is being authenticated, while content is being downloaded in real-time (if necessary based on the current state of the semi-dynamic content), and while content is transferred from the kiosk to the selected delivery device.

The kiosk 20 may then assemble the user data, kiosk data, community data, location data, and any other information into the collected data and communicate it to the server 10 (or any other device), as shown at block 76. Any device or apparatus that can collect and gather such data can be used. Examples of such devices may include data gathering devices, such as hand-held units, as well as the hardware and software components in the kiosk 20 mentioned above.

When the server 10 receives the collected data, it may be optionally collated, analyzed, summarized, or otherwise processed on a server using a variety of procedures. The server 10 may also be configured to use the collected data from one or more kiosks 20 as a factor in determining what content to push to each kiosk 20, what advertising messages to push to each kiosk 20, etc.

As depicted at 78 in FIG. 3, the collected data can then be shared and made available to the community of users and/or non-users. For instance, once a community has been formed, any desired collected data may be shared among the community. Thus, the system can also be used to make information or data about a particular user and/or the user's activities at a kiosk available to other members of any desired community, which may users and/or non-users the users invite to the community. Similarly, the systems and methods may also make the information about a particular community available to a single user or non-user. This data can then be used by the individual user or a community for any desired purposes, as is described hereinafter.

This sharing procedure can be initiated in any way. For example, the sharing procedure may be initiated by the user, another user, the location partner, etc. For instance, the user can interact with the kiosk 20, make a selection of the user's favorite songs, and a copy of this list can be sent to a friend or community/network of friends, which may be users or non-users. Or the individual user can select a single song, listen to a 30 second sample of that song, purchase the song, and then send that single selection on to a community or may add additional non-user friends to a community and send the selection to the entire community. Alternatively, the user can agree to the sharing procedure by just indicating that the user belongs to a given community and that the user's selection of a single song can be shared with the community. In this manner, the user's selection may be shared with the community without the user's direct action of purposefully sharing that information with specific users of that community.

In sharing information, it should also be noted that when the user sends information to anyone, the recipient can automatically become a part of the community or can be prompted to become part of that group. Indeed, if the recipient chooses to join a community or otherwise interact with the kiosk and/or its related systems, the recipient may become a user. Additionally, a way to require a user to consent to join a community, recommend an associate to be part of a community, or to have host's consent, can be implanted and used when sharing information.

The collected data may be communicated to any desired party or shared among any community using any known technique. For instance, in one technique, active communication among a community may be initiated by the user using, for example, instant messaging, blogs, e-mail, EDI, or uploading of data to a separate computer that is accessible to one or more members of the community. In a second technique, the community may be provided with access to the server 10 on which kiosk data is stored, or another server controlled by the same or an affiliated entity that controls the first server. This technique may permit the community—or individual members of the community—to access the collected data at times determined by them. One example of a communication method by which a community—or individual members of the community—may access kiosk data on a server 10 is via a Web page provided by the entity that controls the server 10. In one embodiment, this Web page may be provided by the same Web server that provides a Web page embodiment of a kiosk 20, with the server 10 providing appropriate information. Further, the Web page may allow members of a community to chat, blog, instant message, post comments, etc.

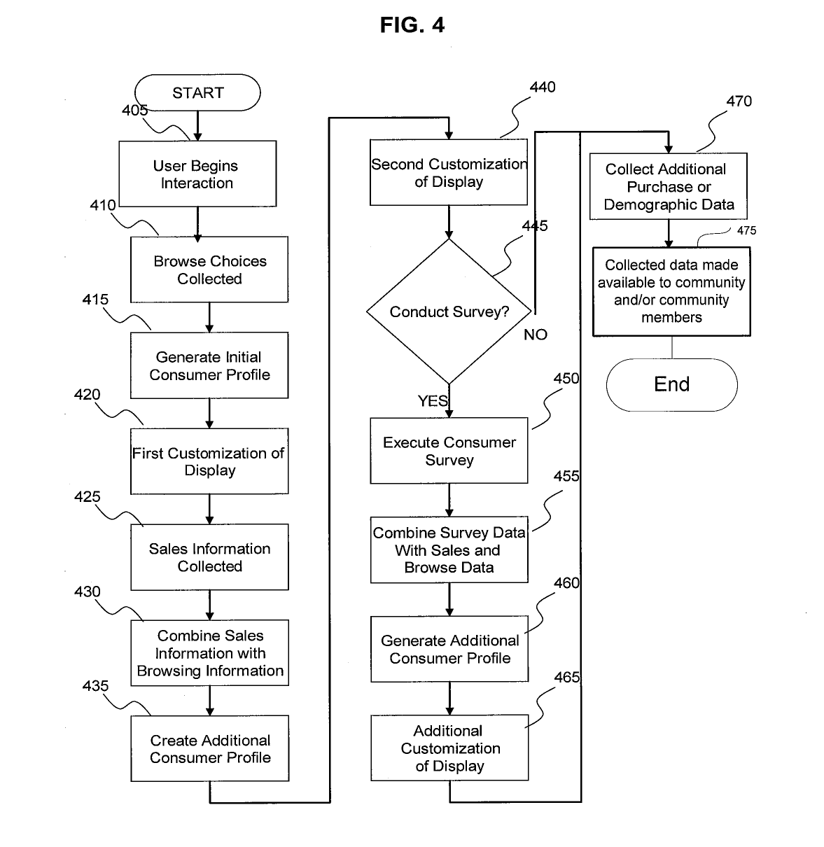

A specific example of how the collected data may be gathered and shared is illustrated in FIG. 4. As depicted at block 405 in FIG. 4, the process of sharing data/information at the kiosk may begin when the user interacts with the kiosk 20. As shown in block 410 of FIG. 4, the user's browsing choices can be collected using the system described above. These browsing choices can be used to create an initial user profile as shown at block 415. At block 420, the system can use this initial profile to initially customize the information and/or options displayed to the user. For example, after a user browses the display and repeatedly selects media of a specific genre (i.e., songs performed by women country artists), the system can automatically update the display to contain advertisements of women country artists as well as links to various communities relating to country women artists.

After the user has purchased some digital content, the sales information can be collected, as shown at block 425 in FIG. 4. Next, at block 430, this sales information may be combined with the previously collected user data, such as browsing and conversion information. Then, as shown in block 435, an additional user profile may then be created. At block 440, the data gathered so far can then be used as a factor to perform a second customization of the advertising and community links, which may now be even more targeted and customized to the individual user.

As depicted at block 445 in FIG. 4, the user can then optionally choose to join a community or add other's name and contact information to an existing community, answer an optional survey, or otherwise input additional collected data. If the user chooses to input additional collected data, as shown at block 450, this process may optionally be completed while payment information is being authenticated, while content is being transferred to the kiosk, and/or while the content is transferred from the kiosk to the selected delivery device. As portrayed in block 455, user data, community data, and the like may then be combined with all of the other collected data, to generate an additional user profile (at block 460). Next, at block 465, an additional customization of the advertising display may then be completed. For instance, as part of this customization, the advertising display may ask if the user would like to send a sample of purchased content to a friend, or if the user would like to invite a friend to a community the user recently joined. At block 470, even if the user has not joined a community, answered a survey, etc., additional purchase or demographic data may still be collected. Then, as shown at block 475, the collected data may then be sent to or made available to members of a community in any manner, as described above.

In some embodiments, the collected data obtained from the user can include the user's email account. That account can be used to further customize the kiosk experience for the user. As well, that email account can be used to allow the user to receive additional electronic advertising, including notices of upcoming content, events, products, and similar topics. The user's email account may also be used when sharing the information among a community to which the user belongs. In other embodiments, the collected data may include e-mail addresses of additional people the user would like to join or invite to the community. Similarly, these addresses may be used to allow people indicated by the user to receive an invitation to join a community; notices of upcoming content, events, products, etc.; product samples; and similar information. In both embodiments, the system can create individual membership accounts for a user or someone the user invites to join a community. These accounts can be used to further customize the kiosk experience for the user, community member, and/or potential community member.

In some embodiments, a user may establish a user account without using the kiosk 20, i.e., via a Web page that is linked to the system. For instance, during interaction with the kiosk, a user may enter a non-user friend's email address and invited the friend to join the community. The friend may then establish a user account via a Web page. User accounts established via a Web page may permit a server 10 to track with more precision the activity of the user across multiple kiosks 20, browsing sessions, and purchase transactions. As well, when a user, community member, or potential community member views, selects, purchases, etc. any content via a Web page that is linked to the system, the same data that is collected at kiosk can be collected via the Web page and then be shared with the community. Likewise, the individual user may access or use any of the community data that has been shared among any or all of the members or one or more communities at the kiosk (or even a Web page) at a Web page.

The collected data can be shared among the community, its individual members, and/or potential members by either transmitting the data to them or by allowing them to access the central device either directly or indirectly through the Web page/Web portal. In the former situation, the collected data may be optionally collated, analyzed, summarized, or otherwise processed using a variety of steps. This situation may allow the operator of the system to perform the analysis, filter the results, and/or customize the data that is sent to the community and/or its individual members. In the latter situation, the community and/or its individual members can view the collected data before (or as) it is received from the remote devices or anytime during the analysis, filtering, or customization process. Of course, access to the central device by the community and/or its individual members can be established using any parameters desired by the operator of the system and/or the individual user that provided the data, i.e., access may be limited to only certain portions of the collected data.

In certain situations, the collected data can be sent directly to other kiosks. Such situations can be advantageous when the community and/or its individual members want to access data from a group of kiosks in the same location or vicinity. In these situations, the data can be transmitted to-or-from the secondary remote device, allowing the community and/or its individual members to access the collected data for both remote device(s). This situation may give the community and/or its individual members more access to the raw data that has been collected, but does not necessarily allow the user of the system to analyze, filter, or customize the report. Again, access to the collected data can be established using any parameters desired by the operator of the system, i.e., access may be limited to only certain portions of the collected data.

The collected data may also be reported to third parties other than the community and/or its individual members. The types of third parties may include the location partners, content providers or other third parties designated by content providers, including copyright owners. If content providers, copyright owners, or others are due royalties or other payments based on use or sale of content, such royalties or other payments may be made from the operator of a server to the appropriate recipient using automated means as are known in the art, based upon sales and demographic data. A system operator can also authorize any third party to receive reports and restrict the reports that the third party can access.

All of the collected data from the remote device(s), Web portal, and/or Web page can be used for numerous purposes. In some aspects, the collected data can be used to enhance and/or customize the operation of the system. In other aspects, the collected information can be part of the general and specific market research data that can be used by the operator of the system as known in the art. In yet other aspects, the collected information can be used to customize the content and/or the advertising provided to the community and/or its individual members. For example, the collected data can be used to customize the content delivered to the kiosk or be used to predict the types/genre of media that will be popular to a given community or sub-community. Alternatively, the collected data can be used to customize the digital content by the time of day, the geographic location, etc.

The collected data can be used to customize the advertising directed to the community and/or its individual members. The advertising may include messages used to market, promote, or sell products or services; or to enhance brand recognition, as well as training materials, entertainment content, community or location information, and other similar materials. The advertising may also include video clips, audio clips, ring tones, printed coupons, promotional codes, brochures, literature, images, giveaways, discounts associated with digital content, or other promotional or brand-related content. In some embodiments, the advertising may be presented through video and/or audio presentations, animated PowerPoint presentations, flash programs, banners, pop-ups, screen-savers, wallpapers, posters, digital sampling, cost-per-pixel, cost-per-click, advertisement images, printed advertisements, trademarks and other similar advertisements. One example of the advertising includes the promotion of artists or performers, whose products or content are available for sale on the kiosk.

The collected data can also be used so a given user can access a kiosk or Web page and access all of the community data. For example, a user may log on to a Web site, enter in the community name/identification of which the user is a member, and that user can then see what music the user's friends in the community are listening to and/or buying. The user can see the same information when accessing the community data at a kiosk. As well, the operator of the system and the third parties could access the same information, if the community is configured in that manner.

In still another example of the use of the collected data, it may be used in any method of viral marketing. When a user purchases content, a sample of the purchased content may be sent to friends of the user or to the community the user has defined. The recipients of the sample sent from the user may then send the sample on to other friends, who may send the sample on to other, and so forth. For example, if a user purchases a song or a movie, a short clip of the purchased content may be sent to the user's defined community, along with any message the user may choose include. The recipients of the clip and message may then forward that message on to others. In another example, samples of recently released content may be sent to a relevant community. In turn, the community may choose to send the sample content on to others who are not members of the community, or even to other users of the kiosk who belong to a different community.

Indeed, the recipients of the sample content or community data may interact with the content or data in any desired manner. In one example of how a recipient may interact with the sample content, the sample content may include a link, which, when clicked on, allows the recipient to purchase the content received or to browse for other content. Similarly, the recipient may be able to vote on, rate, and/or comment on the received content. Votes, ratings, and/or comments may then be relayed to other friends or communities and may also be collected and communicated to the server. In another example of recipient interaction, a recipient who is not currently a member of a community and/or a user of the kiosk may click on a link that allows the recipients to join a community. In so doing, the recipient may choose to join a community, create a new community, or expand an existing community by sending the link on to other friends. In yet another example of recipient interaction, the recipient may forward the sample content, along with any desired message, to other friends and/or groups, who may then send the sample content on to other friends. For instance, a recipient may send the sample content to others by clicking on a “tell a friend” link and then entering e-mail addresses of others.

The information shared between a member of a community and the community to which he belongs (and vice versa) allows several functionalities. First, as a community and its individual members access and use digital content, rate the content, or/and purchase the content, the feedback and usage of that content may be available to any and/or all the members of that community. Thus, the collective feedback and knowledge of the entire community can be made to any and all the members simultaneously. In other words, any individual community member can access and view this information at any given time and be able to get updates, comments, messages, ratings, and any other desired information imaginable. The sharing the community data and other information may be used to build a base of information that has never been gathered and reported on before.

Another functionality of sharing collected data and other information among a community includes increased communication. This increased communication may occur not just between users, but among non-users as well. For example, sharing information may allow users to identify and communicate with other users about the kiosk, Web page, content, or related matters. In an example of communication between users and non-users, a user may be able to send information about products, the kiosk, Web page, etc. to a non-user or invite a non-user to join the community.

This increased communication, in turn, increases user and non-user awareness of any facets of the kiosk, Web page, content, etc. For example, the communication between members of a community may increase user awareness of available products, popularity of products, promotions, updates, up coming events, and the like. In another example, as members of the community invite non-users to join a community, non-user awareness may increase with respect to the community, the kiosk, the Web page, content, products, and so forth. Thus, increased communication and awareness may result in increased numbers of users as well as increased revenue generation.

Another function besides the information exchange ability, includes the purchasing power of the individual member when belonging to a community. For example, because a community may have many members, individual members may be able to obtain lower pricing when purchasing the content. In addition to giving bargaining power to a community to reduce purchase price, membership in a community may increase bargaining power for other types of conditions to purchase (e.g., requiring that some of the purchase price be donated to a charity or a certain cause like breast cancer research, PETA, etc.).

Of course, the community and rules for sharing the data between a member and the community (and vice versa) can be configured in any desired manner. For example, the individual user who is a member can restrict what information is shared with the community and when it is shared. As well, the community can also restrict and regulate what information is shared and the conditions under which it is shared or accessed. As well, the operator (and even any third party) of the system can set up rules and regulations for the community.

The methods and systems described above may have any desired variation. For instance, in one variation on the systems and methods described above, a user can interact with a kiosk 20 to select and purchase content, but selects a delivery device that is not co-located with the kiosk 20 at which the original interaction and purchase occurred (the “delivery location”). As one example, a user could interact with a server using a Web page embodiment of a kiosk 20 and then select a separate kiosk 20 having a CD-burning output device as the delivery location. As a second non-limiting example, an end-user could interact with a server 10 via a first kiosk 20 having two video displays and a CD burner, but then discover that the end-user's preferred delivery device, an audio CD, was unavailable because all blank audio CDs at that particular kiosk 20 has been used. The end-user could then select as the delivery location a kiosk 20 located in another building on the same campus where blank audio-CDs were available; or the end-user could select a Web page embodiment as the delivery location and a download to hard disk as the delivery device.

In another variation on the systems and methods described above, the entity that operates a server 10 or kiosk 20 may receive a fee or services in exchange for its part in the collection and sharing of information among the members of a community.

In another variation on the systems and methods described above, a first device comprises a kiosk and a second device comprises a peripheral that may optionally be located remotely from that kiosk.

In still another variation on the systems and methods described above, multiple kiosks 14 may be linked in a manner such that purchases are completed on one or more kiosks 20 but the delivery location for all such purchases is a designated delivery device located on a specific kiosk 20. As one example, a retail establishment could maintain multiple kiosks 14 at which customers could browse available content. After purchase of content through any of those multiple kiosks 14, all end-users would collect an audio CD, DVD video disk, or other delivery device from a separate kiosk 20 that was designed for high-volume generation of such delivery devices.

In addition to any previously indicated variation, numerous other modifications and alternative arrangements may be devised by those skilled in the art without departing from the spirit and scope of the invention and appended claims are intended to cover such modifications and arrangements. Thus, while the invention has been described above with particularity and detail in connection with what is presently deemed to be the most practical and preferred aspects of the invention, it will be apparent to those of ordinary skill in the art that numerous modifications, including but not limited to, form, function, manner of operation and use may be made without departing from the principles and concepts set forth herein.

1. A method for sharing information among a community of kiosk users or non-users, comprising:
providing a kiosk containing digital content;
establishing a community of members comprising kiosk users and non-users;
collecting data about a user or the user's interaction with the digital content at the kiosk; and
sharing a portion of that collected data with the community.

2. The method of claim 1, wherein the collected data can be accessed by a single member or a plurality of members of the community.

3. The method of claim 1, further comprising assembling the collected data with data collected from other community members and their interaction with a kiosk or with the community.

4. The method of claim 3, wherein the assembled information can be accessed at a location other than the kiosk.

5. The method of claim 4, wherein that location comprises a Web page.

6. The method of claim 1, wherein the collected data can be used to create a profile for the user, for the community, or both.

7. The method of claim 1, wherein the collected data can be used to customize the digital content offered to a user at the kiosk.

8. The method of claim 1, wherein the collected data can be used to customize the digital content offered to the community at the kiosk.

9. The method of claim 1, including providing a system that contains a server and the kiosk, wherein the server and the kiosk are in electronic communication with each other.

10. A computer-implemented method for sharing information among a community of kiosk users or non-users, the method comprising:
providing a system, the system containing a server and first and second kiosks containing digital content;
establishing a community of members comprising kiosk users and non-users;
collecting data about a user or the user's interaction with the digital content at a first kiosk; and
electronically communicating the collected data from the first kiosk to the server, to the second kiosk, or to both; and
sharing a portion of that collected data with the community.

11. The method of claim 10, wherein the collected data can be accessed by a single member or a plurality of members of the community.

12. The method of claim 10, further comprising assembling the collected data with data collected from other community members and their interaction with the community.

13. The method of claim 12, wherein the assembled information can be accessed at a location other than the kiosk.

14. The method of claim 13, wherein that location comprises a Web page.

15. The method of claim 10, wherein the collected data can be used to create a profile for the user, for the community, or both.

16. The method of claim 10, wherein the collected data can be used to customize the digital content offered to a community member at the kiosk.

17. A computer-implemented method for creating a community of kiosk users or non-users, the method comprising:
providing a system containing a server and a kiosk containing digital content;
collecting data about a user or the user's interaction at the kiosk;
electronically communicating the collected data from the kiosk to the server;
establishing a community of members comprising kiosk users and non-users based on the collected data.

18. The method of claim 17, wherein the collected data can be accessed by a single member or a plurality of members of the community.

19. The method of claim 17, further comprising assembling the collected data with data collected from community members other than the user and the community members' interaction within the community.

20. The method of claim 19, wherein the assembled data can be used to customize the digital content offered to any community member at the kiosk.
